(19) United States
(12) Patent Application Publication
(10) Pub. No.: US 2025/0256608 A1
(43) Pub. Date: Aug. 14, 2025

(54) CHARGE POWER-SUPPLY MANAGEMENT SYSTEM

(71) Applicant: HONDA MOTOR CO., LTD., Tokyo (JP)

(72) Inventor: Hidekazu SHINTANI, Tokyo (JP)

(21) Appl. No.: 19/045,569

(22) Filed: Feb. 5, 2025

(30) Foreign Application Priority Data
Feb. 9, 2024 (JP) 2024-018514

(51) Int. Cl. B60L 53/64; B60L 53/62; B60L 53/66

(52) U.S. Cl. CPC B60L 53/64; B60L 53/62; B60L 53/66; B60L 2240/72

(57) ABSTRACT

A charge power-supply management system 1 includes a target information acquirer 12 that acquires target information including information on the current location of a target mobile object and the state of an in-vehicle battery, a facility information acquirer 15 that extracts a facility having requested power supply as a power supply requesting facility, a movement cost calculator 16 that calculates a mobile power-supply cost borne by a target user for movement between the current location and the power supply requesting facility, a user benefit calculator 17 that calculates a mobile power-supply benefit that can be obtained by the target user in a case of the power supply to the power supply requesting facility, and a plan transmitter 18 that transmits a mobile power-supply plan to the target mobile object in a case where it is determined that the mobile power-supply benefit is greater than the mobile power-supply cost.

This application is based on and claims the benefit of priority from Japanese Patent Application No. 2024-018514, filed on 9 Feb. 2024, the content of which is incorporated herein by reference.

### BACKGROUND OF THE INVENTION

### Field of the Invention

The present invention relates to a charge power-supply management system. More specifically, the present invention relates to a charge power-supply management system that manages charge of a power storage device mounted on a mobile object and power supply from the power storage device.

### Related Art

In recent years, research and development have been conducted on charge and power supply in a mobile object equipped with a secondary battery which contributes to energy efficiency in order to ensure that more people have access to affordable, reliable, sustainable, and advanced energy.

Many of electric vehicles traveling with power stored in in-vehicle secondary batteries (hereinafter also referred to as “in-vehicle batteries”) have both a charge function of charging the in-vehicle battery with power supplied from an external power source and a power supply function of supplying power stored in the in-vehicle battery to an external load. In recent years, a user of an electric vehicle can charge the electric vehicle and supply power from the electric vehicle not only at the user's home but also at various facilities as destinations of the electric vehicle (see, for example, Japanese Unexamined Patent Application, Publication No. 2020-162395).

Patent Document 1: Japanese Unexamined Patent Application, Publication No. 2020-162395

### SUMMARY OF THE INVENTION

At a power generation facility (i.e., facility including power generation equipment and charge equipment that charges an in-vehicle battery with power generated in the power generation equipment) having extra power for some reason, a user might be able to charge the in-vehicle battery at lower cost than that in a case of charging the in-vehicle battery at home. At a power supply facility (i.e., facility including an electric load and power supply equipment that supplies the electric load with power from an in-vehicle battery) which lacks power for some reason, a user might be able to sell power at a higher price than that in a case of supplying power from the in-vehicle battery to home.

In a case where there are various charge facilities and power supply facilities other than home, the benefit obtained by a user is assumed to vary by charge and power-supply locations. However, conventionally, no study has been sufficiently conducted on at what location the charge and the power supply are performed to provide the greatest benefit to a user.

The present invention is intended to provide a charge power-supply management system that manages charge of a power storage device and power supply from the power storage device such that a user of a mobile object having the power storage device obtains a benefit, and thus contributes to energy efficiency.
(1) A charge power-supply management system (for example, charge power-supply management system 1 described later) according to the present invention is for managing charge of a power storage device (for example, in-vehicle batteries B1, B2, . . . described later) mounted on a target mobile object (for example, mobile objects M1, M2, . . . described later) and power supply from the power storage device, which includes a target information acquirer (for example, target information acquirer 12 described later) that acquires target information including information on the current location of the target mobile object and the state of the power storage device, a facility information acquirer (for example, facility information acquirer 15 described later) that extracts, as a power supply requesting facility, a facility having requested the power supply from a plurality of facilities (for example, facilities F1, F2, F3, . . . described later) in a target area including the current location and acquires power supply requesting facility information on the power supply requesting facility, a margin determinator (for example, margin determinator 14 described later) that determines the presence or absence of a power supply margin in the power storage device based on the target information, a movement cost calculator (for example, movement cost calculator 16 described later) that calculates, as a mobile power-supply cost, a cost borne by a target user of the target mobile object for movement of the target mobile object between the current location and the power supply requesting facility, a user benefit calculator (user benefit calculator 17 described later) that calculates, as a mobile power-supply benefit, a benefit that can be obtained by the target user in a case of the power supply from the power storage device to the power supply requesting facility, and a plan transmitter (for example, plan transmitter 18 described later) that transmits a mobile power-supply plan generated based on the target information and the power supply requesting facility information to a target terminal of the target user or the target mobile object in a case where it is determined that the power storage device has the power supply margin and the mobile power-supply benefit is greater than the mobile power-supply cost.
(2) Preferably, in this case, in a case where the current location is the same as the location of a target station set for the target mobile object, the user benefit calculator calculates, as a station power supply benefit, a benefit that can be obtained by the target user in a case of the power supply from the power storage device to the target station, and in a case where a differential benefit obtained by subtracting the mobile power-supply cost from the mobile power-supply benefit is greater than the station power supply benefit, the plan transmitter transmits the mobile power-supply plan to the target terminal or the target mobile object.
(3) Preferably, in this case, in a case where the target mobile object is an electric vehicle traveling with power from the power storage device, the movement cost calculator calculates the mobile power-supply cost based on the electricity consumption of the target mobile object and an electricity unit price at the target station.
(4) Preferably, in this case, the charge power-supply management system further includes a use schedule determinator (for example, use schedule determinator 13 described later) that determines whether or not use of the target mobile object is scheduled up to a predetermined time ahead of the current point in time, and in a case where it is determined that the power storage device has the power supply margin and there is no schedule of use of the target mobile object and the differential benefit is greater than the station power supply benefit, the plan transmitter transmits the mobile power-supply plan to the target terminal or the target mobile object.
(5) Preferably, in this case, in a case where the target mobile object is an unmanned self-driving vehicle, the plan transmitter transmits, to the target mobile object, the mobile power-supply plan including information necessary for automatic movement of the target mobile object from the current location to the power supply requesting facility.
(6) Preferably, in this case, the user benefit calculator successively calculates the mobile power-supply benefit based on the latest power supply requesting facility information, and in a case where the differential benefit becomes less than the station power supply benefit while the target mobile object is moving toward the power supply requesting facility, the plan transmitter transmits a notification of cancelling the notified mobile power-supply plan.
(7) A charge power-supply management system (for example, charge power-supply management system 1 described later) according to the present invention is for managing charge of a power storage device (for example, in-vehicle batteries B1, B2, . . . described later) mounted on a target mobile object (for example, mobile objects M1, M2, . . . described later) and power supply from the power storage device, which includes a target information acquirer (for example, target information acquirer 12 described later) that acquires target information including information on the current location of the target mobile object and the state of the power storage device, a facility information acquirer (for example, facility information acquirer 15 described later) that extracts, as a charge requesting facility, a facility having requested the charge from a plurality of facilities (for example, facilities F1, F2, F3, . . . described later) in a target area including the current location and acquires charge requesting facility information on the charge requesting facility, a margin determinator (for example, margin determinator 14 described later) that determines the presence or absence of a charge margin in the power storage device based on the target information, a movement cost calculator (for example, movement cost calculator 16 described later) that calculates, as a mobile charge cost, a cost borne by a target user of the target mobile object for movement of the target mobile object between the current location and the charge requesting facility, a user benefit calculator (for example, user benefit calculator 17 described later) that calculates, as a mobile charge benefit, a benefit that can be obtained by the target user in a case of the charge from the charge requesting facility to the power storage device, and a plan transmitter (for example, plan transmitter 18 described later) that transmits a mobile charge plan generated based on the target information and the charge requesting facility information to a target terminal of the target user or the target mobile object in a case where it is determined that the power storage device has the charge margin and the mobile charge benefit is greater than the mobile charge cost.
(8) Preferably, in this case, the user benefit calculator calculates the mobile charge benefit by subtracting a cost borne by the target user in a case of the charge from the charge requesting facility to the power storage device from a cost borne by the target user in a case of the charge from a target station set for the target mobile object to the power storage device.
(9) Preferably, in this case, in a case where the target mobile object is an electric vehicle traveling with power from the power storage device, the movement cost calculator calculates the mobile charge cost based on the electricity consumption of the target mobile object and an electricity unit price at the target station.
(10) Preferably, in this case, the charge power-supply management system further includes a use schedule determinator (for example, use schedule determinator 13 described later) that determines whether or not use of the target mobile object is scheduled up to a predetermined time ahead of a current point in time, and in a case where it is determined that the power storage device has the charge margin and there is no schedule of use of the target mobile object and the mobile charge benefit is greater than the mobile charge cost, the plan transmitter transmits the mobile charge plan to the target terminal or the target mobile object.
(11) Preferably, in this case, in a case where the target mobile object is an unmanned self-driving vehicle, the plan transmitter transmits, to the target mobile object, the mobile charge plan including information necessary for automatic movement of the target mobile object from the current location to the charge requesting facility.
(12) Preferably, in this case, the user benefit calculator successively calculates the mobile charge benefit based on latest charge requesting facility information, and in a case where the mobile charge benefit becomes less than the mobile charge cost while the target mobile object is moving toward the charge requesting facility, the plan transmitter transmits a notification of cancelling the notified mobile charge plan.
(1) In the present invention, the target information acquirer acquires the target information on the current location of the target mobile object and the state of the power storage device, the facility information acquirer extracts the power supply requesting facility from the plurality of facilities around the current target mobile object (i.e., in a target area) and acquires the power supply requesting facility information on the power supply requesting facility, the margin determinator determines the presence or absence of the power supply margin in the power storage device, the movement cost calculator calculates, as the mobile power-supply cost, the cost borne by the target user for movement of the target mobile object between the current location and the power supply requesting facility, and the user benefit calculator calculates, as the mobile power-supply benefit, the benefit obtained by the user from the power supply from the power storage device to the power supply requesting facility. Moreover, the plan transmitter transmits the mobile power-supply plan generated based on the target information and the power supply requesting facility information to the target terminal of the target user or the target mobile object in a case where it is determined that the power storage device has the power supply margin and the mobile power-supply benefit is greater than the mobile power-supply cost, i.e., a case where it can be determined that the target user can obtain the benefit in a case of the power supply at the destination after movement of the target mobile object from the current location to the power supply requesting facility. With this configuration, the target user can recognize that the target user can obtain the benefit in a case of the power supply at the destination after movement of the target mobile object to the power supply requesting facility. This can prompt the target user to move the target mobile object to the power supply requesting facility and supply power at the destination, and therefore, the target user can obtain the benefit. The target user is prompted to perform the power supply at the facility having a high demand for the power supply as described above, and as a result, an unnecessary demand response can be avoided, which contributes to energy efficiency improvement.
(2) In the present invention, in a case where the current location is the same as the location of the target station set for the target mobile object, the user benefit calculator calculates, as the station power supply benefit, the benefit that can be obtained by the target user in a case of the power supply from the power storage device to the target station, and in a case where the differential benefit obtained by subtracting the mobile power-supply cost from the mobile power-supply benefit is greater than the station power supply benefit, i.e., a case where a greater benefit is obtained in a case where the target mobile object is moved to the power supply requesting facility and the power supply is performed at such a destination than in a case where power is supplied to the target station without moving the target mobile object from the target station, the plan transmitter transmits the mobile power-supply plan to the target terminal or the target mobile object. With this configuration, the target user can more reliably obtain the benefit.
(3) A user of an electric vehicle often charges a power storage device at a particular target station. For this reason, in a case where the target mobile object is the electric vehicle traveling with power from the power storage device, the movement cost calculator calculates the mobile power-supply cost based on the electricity consumption of the target mobile object and the electricity unit price at the target station. With this configuration, the accuracy of the benefit obtained by the user in a case where the power supply is performed based on the mobile power-supply plan can be enhanced.
(4) In the present invention, the use schedule determinator determines whether or not use of the target mobile object is scheduled up to the predetermined time ahead of the current point in time, and in a case where it is determined that the power storage device has the power supply margin and there is no schedule of use of the target mobile object and the differential benefit is greater than the station power supply benefit, the plan transmitter transmits the mobile power-supply plan to the target terminal or the target mobile object. With this configuration, even if the target mobile object is an object assumed to be used by an unspecified person other than the target user, the target user can obtain the benefit using time for which the target mobile object is not used.
(5) In the present invention, in a case where the target mobile object is the unmanned self-driving vehicle, the plan transmitter transmits, to the target mobile object, the mobile power-supply plan including the information necessary for automatic movement of the target mobile object from the current location to the power supply requesting facility. With this configuration, the target mobile object can be automatically moved to the power supply requesting facility, and can supply power at such a destination.
(6) The demand for power at the power supply requesting facility changes successively. For this reason, the user benefit calculator successively calculates the mobile power-supply benefit based on the latest power supply requesting facility information, and in a case where the differential benefit becomes less than the station power supply benefit while the target mobile object is moving toward the power supply requesting facility, the plan transmitter transmits the notification of cancelling the notified mobile power-supply plan to the target terminal or the target mobile object. This makes it possible to minimize the disadvantage to the target user.
(7) In the present invention, the target information acquirer acquires the target information on the current location of the target mobile object and the state of the power storage device, the facility information acquirer extracts the charge requesting facility from the plurality of facilities around the current target mobile object (i.e., in the target area) and acquires the charge requesting facility information on the charge requesting facility, the margin determinator determines the presence or absence of the charge margin in the power storage device, the movement cost calculator calculates, as the mobile charge cost, the cost borne by the target user for movement of the target mobile object between the current location and the charge requesting facility, and the user benefit calculator calculates, as the mobile charge benefit, the benefit that can be obtained by the target user in a case of the charge from the charge requesting facility to the power storage device. The plan transmitter transmits the mobile charge plan generated based on the target information and the charge requesting facility information to the target terminal of the target user or the target mobile object in a case where it is determined that the power storage device has the charge margin and the mobile charge benefit is greater than the mobile charge cost, i.e., a case where it can be determined that the target user obtains the benefit by the charge at the destination after movement of the target mobile object from the current location to the charge requesting facility. With this configuration, the target user can recognize that the target user obtains the benefit by the charge at the destination after movement of the target mobile object to the charge requesting facility. This can prompt the target user to move the target mobile object to the charge requesting facility and charge the power storage device at the destination, and therefore, the target user can obtain the benefit. The target user is prompted to perform the charge at the facility having a high demand for the charge as described above, and as a result, an unnecessary demand response can be avoided, which contributes to energy efficiency improvement.
(8) In the present invention, the user benefit calculator calculates the mobile charge benefit by subtracting the cost borne by the target user in a case of the charge from the charge requesting facility to the power storage device from the cost borne by the target user in a case of the charge from the target station to the power storage device. With this configuration, the target user can more reliably obtain the benefit.
(9) In the present invention, in a case where the target mobile object is the electric vehicle traveling with power from the power storage device, the movement cost calculator calculates the mobile charge cost based on the electricity consumption of the target mobile object and the electricity unit price at the target station. With this configuration, the accuracy of the benefit obtained by the user in a case where the charge is performed based on the mobile charge plan can be enhanced.
(10) In the present invention, the use schedule determinator determines whether or not use of the target mobile object is scheduled up to the predetermined time ahead of the current point in time, and in a case where it is determined that the power storage device has the charge margin and there is no schedule of use of the target mobile object and the mobile charge benefit is greater than the mobile charge cost, the plan transmitter transmits the mobile charge plan to the target terminal or the target mobile object. With this configuration, even if the target mobile object is an object assumed to be used by an unspecified person other than the target user, the target user can benefit from the time the target mobile object is not in use.
(11) In the present invention, in a case where the target mobile object is the unmanned self-driving vehicle, the plan transmitter transmits, to the target mobile object, the mobile charge plan including the information necessary for automatic movement of this mobile object from the current location to the charge requesting facility. With this configuration, the target mobile object can be automatically moved to the charge requesting facility, and can be charged at such a destination.
(12) The demand for power at the charge requesting facility changes successively. For this reason, the user benefit calculator successively calculates the mobile charge benefit based on the latest charge requesting facility information, and in a case where the mobile charge benefit becomes less than the mobile charge cost while the target mobile object is moving toward the charge requesting facility, the plan transmitter transmits the notification of cancelling the notified mobile charge plan to the target terminal or the target mobile object. This makes it possible to minimize the disadvantage to the target user.

### BRIEF DESCRIPTION OF THE DRAWINGS

FIG. 1 is a view schematically showing a charge power-supply management system according to one embodiment of the present invention and a partial configuration of a management area of the charge power-supply management system; and

FIG. 2 is a functional block diagram showing the configuration of the charge power-supply management system.

### DETAILED DESCRIPTION OF THE INVENTION

Hereinafter, a charge power-supply management system according to one embodiment of the present invention will be described with reference to the drawings.

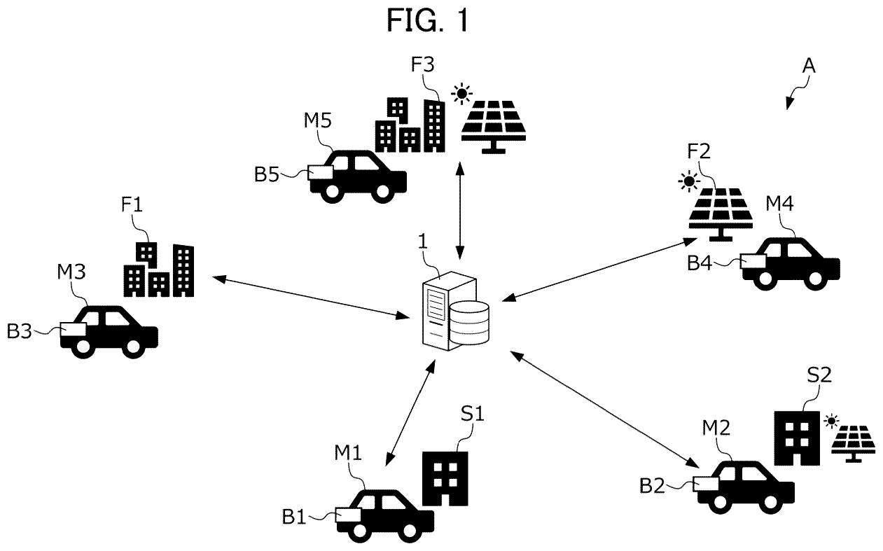

FIG. 1 is a view schematically showing the charge power-supply management system 1 according to the present embodiment and a partial configuration of a management area A of the charge power-supply management system 1. In the management area A, there are a plurality of mobile objects M1, M2, M3, M4, M5, . . . , a plurality of facilities F1, F2, F3, . . . capable of charging secondary batteries (hereinafter, a secondary battery mounted on a mobile object will also be referred to as an “in-vehicle battery”) B1, B2, B3, B4, B5, . . . as power storage devices mounted on the mobile objects M1, M2, . . . and receiving power supplied from the secondary batteries B1, B2, B3, B4, B5, . . . , charge power-supply stations S1, S2, . . . , and the like.

The first facility F1 is a power supply facility including an electric load, a plurality of secondary batteries (hereinafter a secondary battery provided at a facility will also be referred to as a “facility battery” in order to distinguish such a battery from the in-vehicle batteries B1, B2, . . . and the like), and power supply equipment that supplies the electric load with power supplied from the facility batteries and the in-vehicle battery.

That is, a user of the third mobile object M3 at the first facility F1 connects the in-vehicle battery B3 to the power supply equipment, and in this manner, power stored in the in-vehicle battery B3 can be supplied to the electric load of the first facility F1. The user of the third mobile object M3 supplies power from the in-vehicle battery B3 to the first facility F1 as described above, and therefore, can obtain a benefit proportional to the product of the amount (hereinafter also referred to as a “supply power amount”) of power supplied from the in-vehicle battery B3 to the first facility F1 and a power purchase unit price set for the first facility F1. Note that hereinafter, an action of a user of a mobile object replacing an in-vehicle battery with a facility battery having a lower remaining level than that of the in-vehicle battery will also be described as power supply. The power purchase unit price set for the first facility F1 changes as necessary according to the demand for power at the first facility F1, the remaining level of the facility battery, the number of facility batteries, or the like.

The second facility F2 is a charge facility including power generation equipment that generates power by renewable energy such as sunlight or wind power, a plurality of facility batteries, and charge equipment that charges the facility batteries and the in-vehicle battery with the power generated in the power generation equipment.

That is, a user of the fourth mobile object M4 at the second facility F2 connects the in-vehicle battery B4 to the charge equipment, and in this manner, can charge the in-vehicle battery B4. In a case where the user of the fourth mobile object M4 charges the in-vehicle battery B4 from the second facility F2, the user needs to pay, to the second facility F2, a cost proportional to the product of the amount (hereinafter also referred to as a “charge power amount”) of power supplied from the second facility F2 to the in-vehicle battery B4 and a power selling unit price set for the second facility F2. Note that hereinafter, an action of a user of a mobile object replacing an in-vehicle battery with a facility battery having a higher remaining level than that of the in-vehicle battery will also be referred to as charge. The power selling unit price at the second facility F2 changes as necessary according to the demand for power at the second facility F2, the remaining level of the facility battery, the number of facility batteries, or the like.

The third facility F3 is a charge power-supply facility including an electric load, a plurality of facility batteries, power supply equipment, power generation equipment, and charge equipment. That is, a user of the fifth mobile object M5 at the third facility F3 can supply power from the in-vehicle battery B5 to the third facility F3, and can charge the in-vehicle battery B5 from the third facility F3. Moreover, as in the above-described facilities F1, F2, the user of the fifth mobile object M5 can obtain a benefit from the power supply, and needs to pay a cost for the charge.

The first charge power-supply station S1 is a home of a user of the first mobile object M1. The first charge power-supply station S1 is a charge power-supply facility including an electric load, power supply equipment, and charge equipment. That is, the user of the first mobile object M1 parks the first mobile object Ml at home, so that power can be supplied from the in-vehicle battery B1 to the first charge power-supply station S1 and the in-vehicle battery B1 can be charged from the first charge power-supply station S1.

In a case where the user of the first mobile object M1 charges the in-vehicle battery B1 from the first charge power-supply station S1, the user needs to pay, to an electric power company, a cost proportional to the product of the charge power amount from the first charge power-supply station S1 to the in-vehicle battery B1 and an electricity unit price set for the first charge power-supply station S1.

Moreover, the user of the first mobile object M1 supplies power from the in-vehicle battery B1 to the first charge power-supply station S1 as described above, and therefore, can obtain a benefit proportional to the power supply amount from the in-vehicle battery B1 to the first charge power-supply station S1. Here, the benefit obtained by the user of the first mobile object M1 by supplying power from the in-vehicle battery B1 to the first charge power-supply station S1 is equivalent to, for example, the decrement of the payment cost from the user to the electric power company due to the power supply from the in-vehicle battery B1 to the first charge power-supply station S1. The user of the first mobile object M1 can obtain the benefit from the power supply from the in-vehicle battery B1 to the first charge power-supply station S1 as described above, but the opportunity of the power supply is limited according to the usage of the electric load at the first charge power-supply station S1.

The second charge power-supply station S2 is a home of a user of the second mobile object M2. The second charge power-supply station S2 is a charge power-supply facility including an electric load, power supply equipment, charge equipment, and power generation equipment. That is, the user of the second mobile object M2 parks the second mobile object M2 at home, so that power can be supplied from the in-vehicle battery B2 to the second charge power-supply station S2 and the in-vehicle battery B2 can be charged from the second charge power-supply station S2.

In a case where the user of the second mobile object M2 charges the in-vehicle battery B2 from the second charge power-supply station S2 as described above, the user needs to pay, to the electric power company, a cost according to the charge power amount from the second charge power-supply station S2 to the in-vehicle battery B2, an electricity unit price set for the second charge power-supply station S2, and the status of power generation of the power generation equipment.

Moreover, the user of the second mobile object M2 supplies power from the in-vehicle battery B2 to the second charge power-supply station S2 as described above, and therefore, can obtain a benefit proportional to the supply power amount from the in-vehicle battery B2 to the second charge power-supply station S2. Here, the benefit obtained by the user of the second mobile object M2 by supplying power from the in-vehicle battery B2 to the second charge power-supply station S2 is equivalent to, for example, the decrement of the payment cost from the user to the electric power company due to the power supply from the in-vehicle battery B2 to the second charge power-supply station S2. The user of the second mobile object M2 can obtain the benefit from the power supply from the in-vehicle battery B2 to the second charge power-supply station S2 as described above, but the opportunity of the power supply is limited according to the usage of the electric load at the second charge power-supply station S2, the status of power generation of the power generation equipment, or the like.

Note that hereinafter, a case where the mobile objects M1, M2, . . . are electric vehicles traveling with power stored in the in-vehicle batteries B1, B2, . . . and private vehicles of the users of the mobile objects M1, M2, . . . will be described, but the present is not limited thereto. The mobile body may be one including an internal-combustion engine that generates traveling drive force by consuming carbon hydride fuel. The mobile body is not limited to the private vehicle of the user, and may be a commercial vehicle (for example, a MaaS vehicle, a ride-share vehicle, or the like) used for a user's business by the user or a person other than the user. Alternatively, the mobile body may be a facility battery transport vehicle that transports or replaces a plurality of facility batteries among the above-described plurality of facilities F1, F2, F3, . . . .

The charge power-supply management system 1 extracts, as a target mobile object, one or more mobile objects from the plurality of mobile objects M1, M2, . . . in the management area A, and transmits a plan related to the charge of the in-vehicle battery of the target mobile object or the power supply from the in-vehicle battery of the target mobile object to a portable information terminal owned by a user (hereinafter also referred to as a “target user”) of the target mobile object or the target mobile object to prompt the target user to perform the charge or the power supply according to the plan. In this manner, the charge power-supply management system 1 manages the charge of the in-vehicle battery of the target mobile object or the power supply from the in-vehicle battery of the target mobile object.

The charge power-supply management system 1 includes one or more computers connected communicable via a base station with the facilities F1, F2, F3, . . . , the charge power-supply stations S1, S2, . . . , the mobile objects M1, M2, . . . , the portable information terminals owned by the users of the mobile objects M1, M2, . . . , and the like (hereinafter, these facilities F1, F2, F3, . . . and the like will also be collectively referred to as “area terminals”) in the management area A. More specifically, the charge power-supply management system 1 includes a server connected to the plurality of facilities F1, F2, F3, . . . and the like via a base station, a network core, and the Internet, an edge server connected to the plurality of area terminals via a base station and a multi-access edge computing (MEC) core, and the like.

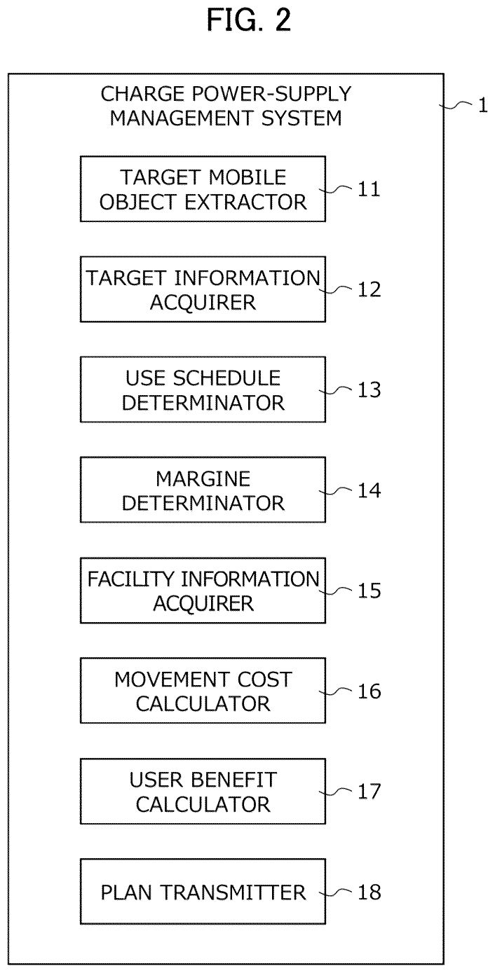

FIG. 2 is a functional block diagram showing the configuration of the charge power-supply management system 1. The charge power-supply management system 1 includes a target mobile object extractor 11, a target information acquirer 12, a use schedule determinator 13, a margin determinator 14, a facility information acquirer 15, a movement cost calculator 16, a user benefit calculator 17, and a plan transmitter 18. The functions of blocks 11 to 18 described below are implemented in such a manner that the charge power-supply management system 1 including the computer(s) executes programs stored in a storage medium (not shown).

The target mobile object extractor 11 extracts, as the target mobile object, one or more mobile objects from the plurality of mobile objects M1, M2, . . . in the management area A.

The target information acquirer 12 acquires target information including the current location of the target mobile object extracted by the target mobile object extractor 11, information on the state of the in-vehicle battery (hereinafter also referred to as a “target battery”) mounted on the target mobile object, information on the state of a target station (i.e., in the example of FIG. 1, the first charge power-supply station S1 is equivalent to a target station of the first mobile object M1, and the second charge power-supply station S2 is equivalent to a target station of the second mobile object M2) of the target mobile object, and the like from the target mobile object, the portable information terminal owned by the target user, the target station, and the like. Here, the target information acquired by the target information acquirer 12 includes information on the current location of the target mobile object, performance information on the performance (i.e., electricity consumption, fuel consumption, and the like) of the target mobile object, type information on the type (i.e., private vehicle, commercial vehicle, and facility battery transport vehicle) of target mobile object, the number of target batteries mounted on the target mobile object, a SOC [%] indicating the current remaining level of each target battery by a percentage, the SOC lower limit of each target battery after mobile power supply, the SOC upper limit of each target battery after mobile charge, information on the degree of degradation of each target battery, the operation rate of the electric load of the target station, the status of power generation by the power generation equipment of the target station, the electricity unit price at the target station, the location of the target station, and the like. The target information acquirer 12 transmits the acquired target information to the margin determinator 14, the movement cost calculator 16, the user benefit calculator 17, the plan transmitter 18, and the like described later.

Here, the SOC lower limit after the mobile power supply is equivalent to the lower limit of the SOC of the target battery after the power supply in a case where the power supply is performed at a facility as a destination based on a later-described mobile power supply plan. Moreover, the SOC upper limit after the mobile charge is equivalent to the upper limit of the SOC of the target battery after the charge in a case where the charge is performed at a facility as a destination based on a later-described mobile charge plan. The SOC lower limit after the mobile power supply and the SOC upper limit after the mobile charge are set in advance, for example, by the target user in order to prevent degradation of the target battery.

The use schedule determinator 13 acquires schedule information indicating a set vehicle as the target mobile object, the set date and time of use of the target mobile object, and the like from the target mobile object or a computer that manages use of the target mobile object. Moreover, the use schedule determinator 13 determines, based on the acquired schedule information, whether or not use of the target mobile object is scheduled up to a predetermined set time ahead of the current point in time. The use schedule determinator 13 preferably determines the schedule of use of the target mobile object as described above particularly in a case where the target mobile object is a commercial vehicle or facility battery transport vehicle which can be used by a person other than the target user.

As described below, during the mobile charge or the mobile power supply based on the plan transmitted from the plan transmitter 18 described later, the target mobile object cannot be basically freely moved from a location set by each plan. For this reason, the use schedule determinator 13 preferably calculates, based on the target information, facility information acquired by the facility information acquirer 15 described later, and the like, a time (hereinafter also referred to as a “vehicle-occupied time”) for which the target mobile object is occupied to execute the plan transmitted from the plan transmitter 18, and determines a time obtained by adding a predetermined margin to the vehicle-occupied time as the above-described set time.

The margin determinator 14 determines, based on the target information acquired by the target information acquirer 12, the presence or absence of a power supply margin or the presence or absence of a charge margin in the target battery mounted on the target mobile object. More specifically, the margin determinator 14 determines that the target battery has the power supply margin in a case where the current SOC of the target battery is greater than a predetermined power supply margin determination value, and determines that the target battery has no power supply margin in a case where the current SOC of the target battery is the power supply margin determination value or less. Moreover, the margin determinator 14 determines that the target battery has the charge margin in a case where the current SOC of the target battery is a charge margin determination value, which is set to a value smaller than the power supply margin determination value, or less, and determines that the target battery has no charge margin in a case where the current SOC of the target battery is greater than the charge margin determination value.

Hereinafter, the processing of the facility information acquirer 15, the movement cost calculator 16, the user benefit calculator 17, and the plan transmitter 18 will be described separately in a case where the margin determinator 14 determines that the target battery has the power supply margin and a case where the margin determinator 14 determines that the target battery has the charge margin. Note that in a case where the margin determinator 14 determines that the target battery has neither the power supply margin nor the charge margin, the target mobile object extractor 11 extracts another mobile object in the management area A as the target mobile object, and the target information acquirer 12, the use schedule determinator 13, and the margin determinator 14 execute the above-described processing on the newly-set target mobile object.

### Case Where Target Battery has Power Supply Margin

In a case where it is determined that there is no schedule of use of the target mobile object and the target battery has the power supply margin, the facility information acquirer 15 sets, as a target area, an area of the management area A including the current location of the target mobile object. Here, the facility information acquirer 15 preferably sets, as the target area, an area centered on the current location of the target mobile object, where at least the target mobile object is movable, for example.

Next, the facility information acquirer 15 extracts, as a power supply requesting facility, a facility having requested the power supply from the plurality of power supply facilities (for example, the first facility F1, the third facility F3, and the like in FIG. 1 except for the charge power-supply stations S1, S2 and the like available only for a particular person) in the set target area, and acquires power supply requesting facility information on the power supply requesting facility. Here, the facility having requested the power supply indicates a facility which lacks power suppliable to the electric load with respect to power required for the electric load. The facility information acquirer 15 extracts, as the power supply requesting facility, a facility at which the operation rate of the electric load is higher than a predetermined reference operation rate, a facility at which power is not stably supplied to the electric load, a facility at which the SOC of the facility battery is a predetermined reference SOC or lower, a facility at which the number of facility batteries is a predetermined number or less, or the like. Moreover, the power supply requesting facility information acquired by the facility information acquirer 15 includes, for example, information on the location of the power supply requesting facility, information on a power purchase unit price at the power supply requesting facility, the number of facility batteries, the SOC of each facility battery, the degree of degradation of each facility battery, and the like.

In a case where it is determined that there is no schedule of use of the target mobile object and the target battery has the power supply margin and the power supply requesting facility is extracted from the target area, the movement cost calculator 16 calculates, as a mobile power-supply cost, a cost borne by the target user for movement of the target mobile object between the current location and the power supply requesting facility. Note that in the present embodiment, a case where the movement cost calculator 16 calculates, as the mobile power-supply cost, the cost (i.e., one-way trip cost) borne by the target user in a case where the target mobile object moves from the current location to the power supply requesting facility will be described, but the present invention is not limited thereto. That is, the movement cost calculator 16 may calculate, as the mobile power-supply cost, the cost (i.e., round-trip cost) borne by the target user in a case where the target mobile object makes a round trip between the current location and the power supply requesting facility.

The movement cost calculator 16 calculates the mobile power-supply cost defined as described above based on the target information, the power supply requesting facility information, and the like. More specifically, in a case where the target mobile object is an electric vehicle traveling with power from the target battery, the movement cost calculator 16 calculates the mobile power-supply cost based on the electricity consumption of the target mobile object, an electricity unit price at the target station for the target mobile object, a distance between the current location and the power supply requesting facility, and the like. In other words, the movement cost calculator 16 calculates the mobile power-supply cost, assuming that the power necessary for moving the target mobile object is charged at the target station. Note that in a case where the power generation equipment is provided as in the second charge power-supply station S2, the movement cost calculator 16 may calculate the mobile power-supply cost based on the electricity consumption of the target mobile object, the electricity unit price at the target station, the distance between the current location and the power supply requesting facility, and the status of power generation of the power generation equipment. In a case where the target mobile object is one traveling with traveling drive force generated in an internal-combustion engine, the movement cost calculator 16 calculates the mobile power-supply cost based on the fuel consumption of the target mobile object, the unit price of carbon hydride fuel, the distance between the current location and the power supply requesting facility, and the like.

In a case where a facility usage fee (entrance fee, parking fee, and the like) is set for the power supply requesting facility, the movement cost calculator 16 preferably includes the facility usage fee in the mobile power-supply cost.

In a case where it is determined that there is no schedule of use of the target mobile object and the target battery has the power supply margin and the power supply requesting facility is extracted from the target area, the user benefit calculator 17 calculates, as a mobile power-supply benefit, a benefit that can be obtained by the target user in a case of the power supply from the target battery to the power supply requesting facility. In the case of the power supply from the target battery to the first facility F1 or the third facility F3 as described above, the target user can obtain a benefit according to the supply power amount.

The user benefit calculator 17 calculates the mobile power-supply benefit defined as described above based on the target information, the power supply requesting facility information, and the like. More specifically, the user benefit calculator 17 initially calculates a target SOC for the target battery after the power supply at the power supply requesting facility. The target SOC is set to a value smaller than the current SOC of the target battery and greater than the SOC lower limit after the mobile power-supply. Here, in a case where a destination after the power supply at the power supply requesting facility has been set for the target mobile object, the user benefit calculator 17 may set the target SOC in consideration of power required for movement from the power supply requesting facility to the above-described destination.

Moreover, the user benefit calculator 17 calculates, as a predicted supply power amount, the amount of power suppliable from the target battery to the power supply requesting facility based on a difference between the current SOC of the target battery and the target SOC. Further, the user benefit calculator 17 calculates the mobile power-supply benefit based on the calculated predicted supply power amount and a current power purchase unit price at the power supply requesting facility.

Note that in a case where the current location of the target mobile object is the same as the location of the target station, i.e., a case where the target mobile object is at the target station, the user benefit calculator 17 calculates, as a station power supply benefit, a benefit that can be obtained by the target user in a case where power is supplied from the target battery determined as having the power supply margin as described above to the target station. As described above, the target user can also obtain the benefit in the case of the power supply from the target battery to the target station. Note that the opportunity of the power supply from the target battery to the target station as described above is limited according to the usage of the electric load at the target station. Thus, the user benefit calculator 17 calculates the station power supply benefit as zero in a situation where power cannot be currently supplied from the target battery to the target station.

The residual value of the target battery decreases to no small extent due to the power supply at the power supply requesting facility. For this reason, the user benefit calculator 17 may calculate the mobile power-supply benefit in consideration of the decrement of the residual value of the target battery due to the power supply at the power supply requesting facility.

In a case where it is determined that there is no schedule of use of the target mobile object and the target battery has the power supply margin and the power supply requesting facility is extracted from the target area, the plan transmitter 18 determines whether or not the mobile power-supply benefit calculated by the user benefit calculator 17 is greater than the mobile power-supply cost calculated by the movement cost calculator 16. In a case where the mobile power-supply benefit is greater than the mobile power-supply cost, the plan transmitter 18 generates a mobile power-supply plan based on the target information and the power supply requesting facility information, and transmits the mobile power-supply plan to the portable information terminal owned by the target user or the target mobile object to prompt the target user to perform the mobile power-supply at the power supply requesting facility. Here, the case where the mobile power-supply benefit is greater than the mobile power-supply cost is, in other words, equivalent to a case where the mobile power-supply benefit is positive even after the mobile power-supply cost has been subtracted therefrom. That is, the case where the mobile power-supply benefit is greater than the mobile power-supply cost is, from the point of view of the target user, equivalent to a case where a positive benefit is obtained even in consideration of the cost for movement between the current location and the power supply requesting facility in a case where power is supplied from the target battery to the power supply requesting facility.

Note that as described above, the user benefit calculator 17 calculates the station power supply benefit in a case where the current location of the target mobile object is the same as the location of the target station. Thus, in a case where a differential benefit obtained by subtracting the mobile power-supply cost from the mobile power-supply benefit is greater than the station power supply benefit, the plan transmitter 18 generates a mobile power-supply plan, and transmits the mobile power-supply plan to the portable information terminal owned by the target user or the target mobile object to prompt the target user to perform the mobile power-supply at the power supply requesting facility. Here, the case where the differential benefit is greater than the station power supply benefit is, from the point of view of the target user, equivalent to a case where a greater benefit is obtained in a case where the target mobile object is moved from the current location to the power supply requesting facility and the power supply is performed at such a destination than in a case where power is supplied from the target battery to the target station without moving the target mobile object from the current location.

Here, the mobile power-supply plan includes information on the location of the power supply requesting facility, information on a route between the current location and the power supply requesting facility, and information on a predicted movement time between the current location and the power supply requesting facility, the predicted supply power amount, the target SOC, the mobile power-supply cost, the mobile power-supply benefit, the station power supply benefit, a predicted power supply time at the power supply requesting facility, and the like. In a case where power is supplied from the target battery to the power supply requesting facility by replacement between the facility battery and the target battery as described above, the mobile power-supply plan preferably includes information necessary for specifying the facility battery to be replaced, information on the SOC of the facility battery to be replaced, and the like. Thus, such a mobile power-supply plan is received by the portable information terminal or the target mobile object, so that the target user can recognize that the benefit can be obtained in a case of the power supply at the destination after movement of the target mobile object to the power supply requesting facility. Note that the plan transmitter 18 preferably includes, in the mobile power-supply plan, information (for example, the information on the location of the power supply requesting facility, the information on the route between the current location and the power supply requesting facility, and the like) necessary for unmanned automatic movement of the target mobile object from the current location to the power supply requesting facility, assuming that the target mobile object is an unmanned self-driving vehicle.

The power purchase unit price at the power supply requesting facility may vary by time of day. In this case, the plan transmitter 18 preferably includes, in the mobile power-supply plan, a mobile power-supply benefit in each period of time. Thus, the target user can perform the power supply at the power supply requesting facility while selecting the period of time in which the greatest benefit is obtained. In a case where the power supply is performed at the power supply requesting facility in the period of time selected by the target user as described above, the target user sometimes needs to wait in the vicinity of the power supply requesting facility until the power supply starts at the power supply requesting facility. Assuming this case, the plan transmitter 18 may extract, as a recommended transit point, a facility located in the vicinity of the power supply requesting facility and including an inexpensive parking, and may include information on the recommended transit point in the mobile power-supply plan.

In a case where the target mobile object is the unmanned self-driving vehicle as described above, the target mobile object can basically move and supply power at any time regardless of the convenience of the target user. Thus, in a case where the target mobile object is the unmanned self-driving vehicle and the power purchase unit price at the power supply requesting facility vary by time of day, the plan transmitter 18 preferably includes, in the mobile power-supply plan, information (for example, the time of departure from the current location, the time of arrival at the power supply requesting facility, and the like) necessary for the power supply in the period of time in which the mobile power-supply benefit is maximized.

Note that the demand for power at the power supply requesting facility varies from hour to hour. Thus, after the plan transmitter 18 has transmitted the mobile power-supply plan as described above, the above-described differential benefit or a difference between the differential benefit and the station power supply benefit may turn negative. For this reason, the user benefit calculator 17 preferably successively calculates the mobile power-supply benefit based on the latest power supply requesting facility information even after the mobile power-supply plan has been transmitted, and in a case where the above-described differential benefit or the above-described difference between the differential benefit and the station power supply benefit turns negative while the target mobile object is moving toward the power supply requesting facility, the plan transmitter 18 preferably transmits a notification of cancelling the notified mobile power-supply plan to the portable information terminal owned by the target user or the target mobile object. This makes it possible to minimize the disadvantage to the target user.

In a case of transmitting the mobile power-supply plan to the portable information terminal of the target user or the target mobile object, the plan transmitter 18 may transmit a target user's request for a reservation of use of the power supply requesting facility to the power supply requesting facility to automatically make the reservation of use of the power supply requesting facility. In a case where the reservation of use of the power supply requesting facility cannot be made or a case where it is unclear whether or not the target user can use the power supply requesting facility, the plan transmitter 18 may transmit a mobile power-supply plan related to another power supply requesting facility.

The residual value of the target battery varies by the discharge speed of the target battery at the power supply requesting facility. Thus, in a case where the target user can select the discharge speed of the target battery at the power supply requesting facility, the plan transmitter 18 preferably includes, in the mobile power-supply plan, information on the decrement of the residual value of the target battery for each discharge speed. With this configuration, the target user can select the discharge speed in consideration of a decrease in the residual value of the target battery.

### Case Where Target Battery has Charge Margin

In a case where it is determined that there is no schedule of use of the target mobile object and the target battery has the charge margin, the facility information acquirer 15 sets, as a target area, an area of the management area A including the current location of the target mobile object. Here, the facility information acquirer 15 preferably sets, as the target area, an area centered on the current location of the target mobile object, where at least the target mobile object is movable, for example. Moreover, the facility information acquirer 15 preferably sets a narrower target area in a case where it is determined that the target battery has the charge margin than the target area in a case where it is determined that the target battery has the power supply margin.

Next, the facility information acquirer 15 extracts, as a charge requesting facility, a facility having requested the charge from the plurality of charge facilities (for example, second facility F2, third facility F3, and the like in FIG. 1 except for the charge power-supply stations S1, S2 and the like available only for a particular person) in the set target area, and acquires charge requesting facility information on the charge requesting facility. Here, the facility having requested the charge indicates a facility which has extra power generated in the power generation equipment with respect to power required for facility battery. The facility information acquirer 15 extracts, as the charge requesting facility, a facility at which the SOC of the facility battery is greater than a predetermined reference SOC, a facility at which the number of facility batteries is a predetermined number or less, a facility at which the operation rate of the power generation equipment is higher than a predetermined reference operation rate, or the like. Moreover, the charge requesting facility information acquired by the facility information acquirer 15 includes, for example, information on the location of the charge requesting facility, information on a power selling unit price at the charge requesting facility, the number of facility batteries, the SOC of each facility battery, and the degree of degradation of each facility battery, and the like.

In a case where it is determined that there is no schedule of use of the target mobile object and the target battery has the charge margin and the charge requesting facility is extracted from the target area, the movement cost calculator 16 calculates, as a mobile charge cost, a cost borne by the target user for movement of the target mobile object between the current location and the charge requesting facility. Note that in the present embodiment, a case where the movement cost calculator 16 calculates, as the mobile charge cost, the cost (i.e., one-way trip cost) borne by the target user in a case where the target mobile object moves from the current location to the charge requesting facility will be described, but the present invention is not limited thereto. That is, the movement cost calculator 16 may calculate, as the mobile charge cost, a cost (i.e., round-trip cost) borne by the target user in a case where the target mobile object makes a round trip between the current location and the charge requesting facility.

The movement cost calculator 16 calculates the mobile charge cost defined as described above based on the target information, the charge requesting facility information, and the like. More specifically, in a case where the target mobile object is an electric vehicle, the movement cost calculator 16 calculates the mobile charge cost based on the electricity consumption of the target mobile object, an electricity unit price at the target station for the target mobile object, a distance between the current location and the charge requesting facility, and the like. In other words, the movement cost calculator 16 calculates the mobile charge cost in a manner similar to that of the above-described mobile power-supply cost, assuming that the power necessary for moving the target mobile object is charged at the target station. In a case where the target mobile object is one traveling with traveling drive force generated in an internal-combustion engine, the movement cost calculator 16 also calculates the mobile charge cost in a manner similar to that of the above-described mobile power-supply cost.

In a case where a facility usage fee is set for the charge requesting facility, the movement cost calculator 16 preferably includes the facility usage fee in the mobile charge cost.

In a case where it is determined that there is no schedule of use of the target mobile object and the target battery has the charge margin and the charge requesting facility is extracted from the target area, the user benefit calculator 17 calculates, as a mobile charge benefit, a benefit that can be obtained by the target user in a case of the charge from the charge requesting facility to the target battery.

In the case of the charge from the second facility F2 or the third facility F3 to the target battery as described above, the target user needs to pay a cost according to the charge power amount. Moreover, the target user also needs to pay a cost according to the charge power amount even in the case of the charge from the target station to the target battery. Thus, the user benefit calculator 17 calculates, as the mobile charge benefit, a difference between the cost borne by the target user in the case of the charge from the target station to the target battery and the cost borne by the target user in the case of the charge from the charge requesting facility to the target battery.

More specifically, the user benefit calculator 17 initially calculates a target SOC for the target battery after the charge at the charge requesting facility. The target SOC is set to a value greater than the current SOC of the target battery and smaller than the SOC upper limit after the mobile charge. Moreover, the user benefit calculator 17 calculates, as a predicted charge power amount, the amount of power suppliable from the charge requesting facility to the target battery based on a difference between the current SOC of the target battery and the target SOC. Further, the user benefit calculator 17 calculates, based on the electricity unit price at the target station, a cost borne by the target user if the predicted charge power amount is supplied from the target station to the target battery. In addition, the user benefit calculator 17 calculates, based on a power selling unit price at the charge requesting facility, a cost borne by the target user in a case where the predicted charge power amount is supplied from the charge requesting facility to the target battery. Moreover, the user benefit calculator 17 calculates a mobile charge benefit by subtracting the cost borne by the target user in the case of the charge at the charge requesting facility from the cost borne by the target user in the case of the charge at the target station, the costs being calculated as described above.

The residual value of the target battery decreases to no small extent due to the charge at the charge requesting facility. For this reason, the user benefit calculator 17 may calculate the mobile charge benefit in consideration of the decrement of the residual value of the target battery due to the charge at the charge requesting facility.

In a case where it is determined that there is no schedule of use of the target mobile object and the target battery has the charge margin and the charge requesting facility is extracted from the target area, the plan transmitter 18 determines whether or not the mobile charge benefit calculated by the user benefit calculator 17 is greater than the mobile charge cost calculated by the movement cost calculator 16. In a case where the mobile charge benefit is greater than the mobile charge cost, the plan transmitter 18 generates a mobile charge plan based on the target information acquired by the target information acquirer 12 and the charge requesting facility information acquired by the facility information acquirer 15, and transmits the mobile charge plan to the portable information terminal owned by the target user or the target mobile object. Here, the case where the mobile charge benefit is greater than the mobile charge cost is, in other words, equivalent to a case where the mobile charge benefit is positive even after the mobile charge cost has been subtracted therefrom. That is, the case where the mobile charge benefit is greater than the mobile charge cost is, from the point of view of the target user, equivalent to a case where a positive benefit is obtained even in consideration of the cost for movement between the current location and the charge requesting facility in a case where power is charged from the charge requesting facility to the target battery.

Here, the mobile charge plan includes information on the location of the charge requesting facility, information on a route between the current location and the charge requesting facility, information on a predicted movement time between the current time and the charge requesting facility, the predicted charge power amount, the target SOC, the mobile charge cost, the mobile charge benefit, and a predicted charge time at the charge requesting facility, and the like. In a case where the target battery is charged from the charge requesting facility by replacement between the facility battery and the target battery as described above, the mobile charge plan preferably includes information necessary for specifying the facility battery to be replaced, information on the SOC of the facility battery to be replaced, and the like. Thus, such a mobile charge plan is received by the portable information terminal or the target mobile object, so that the target user can recognize that the benefit can be obtained by the charge at the destination after movement of the target mobile object to the charge requesting facility. Note that as in the above-described mobile power-supply plan, the plan transmitter 18 preferably includes, in the mobile charge plan, information (for example, the information on the location of the charge requesting facility, the information on the route between the current location and the charge requesting facility, and the like) necessary for unmanned automatic movement of the target mobile object from the current location to the charge requesting facility.

The power selling unit price at the charge requesting facility may vary by time of day. In this case, the plan transmitter 18 preferably includes, in the mobile charge plan, a mobile charge benefit in each period of time. Thus, the target user can perform the charge at the charge requesting facility while selecting the period of time in which the greatest benefit is obtained. In a case where the charge is performed at the charge requesting facility in the period of time selected by the target user as described above, the target user sometimes needs to wait in the vicinity of the charge requesting facility until the charge starts at the charge requesting facility. Assuming this case, the plan transmitter 18 may extract, as a recommended transit point, a facility located in the vicinity of the charge requesting facility and including an inexpensive parking, and may include information on the recommended transit point in the mobile charge plan.

In a case where the target mobile object is the unmanned self-driving vehicle as described above, the target mobile object can basically move and be charged at any time regardless of the convenience of the target user. Thus, in a case where the target mobile object is the unmanned self-driving vehicle and the power selling unit price at the charge requesting facility vary by time of day, the plan transmitter 18 preferably includes, in the mobile charge plan, information (for example, the time of departure from the current location, the time of arrival at the charge requesting facility, and the like) necessary for the charge in the period of time in which the mobile charge benefit is maximized.

Note that the demand for power at the charge requesting facility varies from hour to hour. Thus, after the plan transmitter 18 has transmitted the mobile charge plan as described above, a difference between the mobile charge benefit and the mobile charge cost may turn negative. For this reason, the user benefit calculator 17 preferably successively calculates the mobile charge benefit based on the latest charge requesting facility information even after the mobile charge plan has been transmitted, and in a case where the above-described difference between the mobile charge benefit and the mobile charge cost turns negative while the target mobile object is moving toward the charge requesting facility, the plan transmitter 18 preferably transmits a notification of cancelling the notified mobile charge plan to the portable information terminal owned by the target user or the target mobile object. This makes it possible to minimize the disadvantage to the target user.

In a case of transmitting the mobile charge plan to the portable information terminal of the target user or the target mobile object, the plan transmitter 18 may transmit a target user's request for a reservation of use of the charge requesting facility to the charge requesting facility to automatically make the reservation of use of the charge requesting facility. In a case where the reservation of use of the charge requesting facility cannot be made or a case where it is unclear whether or not the target user can use the charge requesting facility, the plan transmitter 18 may transmit a mobile charge plan related to another charge requesting facility.

The residual value of the target battery varies by the charge speed of the target battery at the charge requesting facility. Thus, in a case where the target user can select the charge speed of the target battery at the charge requesting facility, the plan transmitter 18 preferably includes, in the mobile charge plan, information on the decrement of the residual value of the target battery for each charge speed. With this configuration, the target user can select the charge speed in consideration of a decrease in the residual value of the target battery.

According to the charge power-supply management system 1 of the present embodiment, the following effects are produced.
(1) The target information acquirer 12 acquires the target information on the current location of the target mobile object and the state of the target battery, the facility information acquirer 15 extracts the power supply requesting facility from the plurality of facilities around the current target mobile object (i.e., in the target area) and acquires the power supply requesting facility information on the power supply requesting facility, the margin determinator 14 determines the presence or absence of the power supply margin in the power storage device, the movement cost calculator 16 calculates, as the mobile power-supply cost, the cost borne by the target user for movement of the target mobile object between the current location and the power supply requesting facility, and the user benefit calculator 17 calculates, as the mobile power-supply benefit, the benefit obtained by the user from the power supply from the power storage device to the power supply requesting facility. Moreover, the plan transmitter 18 transmits the mobile power-supply plan generated based on the target information and the power supply requesting facility information to the portable information terminal of the target user or the target mobile object in a case where it is determined that the target battery has the power supply margin and the mobile power-supply benefit is greater than the mobile power-supply cost, i.e., a case where it can be determined that the target user can obtain the benefit in a case of the power supply at the destination after movement of the target mobile object from the current location to the power supply requesting facility. With this configuration, the target user can recognize that the target user can obtain the benefit in a case of the power supply at the destination after movement of the target mobile object to the power supply requesting facility. This can prompt the target user to move the target mobile object to the power supply requesting facility and supply power at the destination, and therefore, the target user can obtain the benefit. The target user is prompted to perform the power supply at the power supply requesting facility having a high demand for the power supply as described above, and as a result, an unnecessary demand response can be avoided, which contributes to energy efficiency improvement.
(2) In a case where the current location of the target mobile object is the same as the location of the target station, the user benefit calculator 17 calculates, as the station power supply benefit, the benefit that can be obtained by the target user in a case of the power supply from the power storage device to the target station, and in a case where the differential benefit obtained by subtracting the mobile power-supply cost from the mobile power-supply benefit is greater than the station power supply benefit, i.e., a case where a greater benefit is obtained in a case where the target mobile object is moved to the power supply requesting facility and the power supply is performed at such a destination than in a case where power is supplied to the target station without moving the target mobile object from the target station, the plan transmitter 18 transmits the mobile power-supply plan to the portable information terminal of the target user or the target mobile object. With this configuration, the target user can more reliably obtain the benefit.
(3) In a case where the target mobile object is the electric vehicle traveling with power from the target battery, the movement cost calculator 16 calculates the mobile power-supply cost based on the electricity consumption of the target mobile object and the electricity unit price at the target station. With this configuration, the accuracy of the benefit obtained by the user in a case where the power supply is performed based on the mobile power-supply plan can be enhanced.
(4) The use schedule determinator 13 determines whether or not use of the target mobile object is scheduled up to the predetermined vehicle-occupied time ahead of the current point in time, and in a case where it is determined that the target battery has the power supply margin and there is no schedule of use of the target mobile object and the differential benefit is greater than the station power supply benefit, the plan transmitter 18 transmits the mobile power-supply plan to the portable information terminal of the target user or the target mobile object. With this configuration, even if the target mobile object is an object assumed to be used by an unspecified person other than the target user, the target user can obtain the benefit using time for which the target mobile object is not used.
(5) In a case where the target mobile object is the unmanned self-driving vehicle, the plan transmitter 18 transmits, to the target mobile object, the mobile power-supply plan including the information necessary for automatic movement of the target mobile object from the current location to the power supply requesting facility. With this configuration, the target mobile object can be automatically moved to the power supply requesting facility, and can supply power at such a destination.
(6) The demand for power at the power supply requesting facility changes successively. For this reason, the user benefit calculator 17 successively calculates the mobile power-supply benefit based on the latest power supply requesting facility information, and in a case where the differential benefit becomes less than the station power supply benefit while the target mobile object is moving toward the power supply requesting facility, the plan transmitter 18 transmits the notification of cancelling the notified mobile power-supply plan to the portable information terminal of the target user or the target mobile object. This makes it possible to minimize the disadvantage to the target user.
(7) The target information acquirer 12 acquires the target information on the current location of the target mobile object and the state of the target battery, the facility information acquirer 15 extracts the charge requesting facility from the plurality of facilities around the current target mobile object (i.e., in the target area) and acquires the charge requesting facility information on the charge requesting facility, the margin determinator 14 determines the presence or absence of the charge margin in the target battery, the movement cost calculator 16 calculates, as the mobile charge cost, the cost borne by the target user for movement of the target mobile object between the current location and the charge requesting facility, and the user benefit calculator 17 calculates, as the mobile charge benefit, the benefit that can be obtained by the target user in a case of the charge from the charge requesting facility to the target battery. The plan transmitter 18 transmits the mobile charge plan generated based on the target information and the charge requesting facility information to the portable information terminal of the target user or the target mobile object in a case where it is determined that the target battery has the charge margin and the mobile charge benefit is greater than the mobile charge cost, i.e., a case where it can be determined that the target user obtains the benefit by the charge at the destination after movement of the target mobile object from the current location to the charge requesting facility. With this configuration, the target user can recognize that the target user obtains the benefit by the charge at the destination after movement of the target mobile object to the charge requesting facility. This can prompt the target user to move the target mobile object to the charge requesting facility and charge the target battery at the destination, and therefore, the target user can obtain the benefit. The target user is prompted to perform the charge at the charge requesting facility having a high demand for the charge as described above, and as a result, an unnecessary demand response can be avoided, which contributes to energy efficiency improvement.
(8) The user benefit calculator 17 calculates the mobile charge benefit by subtracting the cost borne by the target user in a case of the charge from the charge requesting facility to the target battery from the cost borne by the target user in a case of the charge from the target station to the target battery. With this configuration, the target user can more reliably obtain the benefit.
(9) In a case where the target mobile object is the electric vehicle traveling with power from the target battery, the movement cost calculator 16 calculates the mobile charge cost based on the electricity consumption of the target mobile object and the electricity unit price at the target station. With this configuration, the accuracy of the benefit obtained by the user in a case where the charge is performed based on the mobile charge plan can be enhanced.
(10) The use schedule determinator 13 determines whether or not use of the target mobile object is scheduled up to the predetermined vehicle-occupied time ahead of the current point in time, and in a case where it is determined that the target battery has the charge margin and there is no schedule of use of the target mobile object and the mobile charge benefit is greater than the mobile charge cost, the plan transmitter 18 transmits the mobile charge plan to the portable information terminal of the target user or the target mobile object. With this configuration, even if the target mobile object is an object assumed to be used by an unspecified person other than the target user, the target user can obtain the benefit using time for which the target mobile object is not used.
(11) In a case where the target mobile object is the unmanned self-driving vehicle, the plan transmitter 18 transmits, to the target mobile object, the mobile charge plan including the information necessary for automatic movement of this mobile object from the current location to the charge requesting facility. With this configuration, the target mobile object can be automatically moved to the charge requesting facility, and can be charged at such a destination.
(12) The demand for power at the charge requesting facility changes successively. For this reason, the user benefit calculator 17 successively calculates the mobile charge benefit based on the latest charge requesting facility information, and in a case where the mobile charge benefit becomes less than the mobile charge cost while the target mobile object is moving toward the charge requesting facility, the plan transmitter 18 transmits the notification of cancelling the notified mobile charge plan to the portable information terminal of the target user or the target mobile object. This makes it possible to minimize the disadvantage to the target user.

One embodiment of the present invention has been described above, but the present invention is not limited thereto. Detailed configurations may be changed as necessary within the scope of the gist of the present invention.

For example, in the above-described embodiment, the charge power-supply management system 1 that manages the charge of the in-vehicle battery and the power supply from the in-vehicle battery includes the server communicable with the mobile object equipped with the in-vehicle battery, but the present invention is not limited thereto. All or some of the components of the charge power-supply management system may be an in-vehicle computer mounted on the mobile object.

At the charge power-supply facility capable of performing both the power supply and the charge at the same facility, such as the third facility F3 shown in FIG. 1, the power supply and the charge can be alternately repeated without moving the target mobile object from such a facility in some cases. Moreover, in some cases, at this charge power-supply facility, the target user may be able to obtain a greater benefit by performing the power supply (or the charge) and then performing the charge (or the power supply) after having waited until the power selling unit price (or the power purchasing unit price) at the charge power-supply facility decreases (or increases). In this case, the plan transmitter 18 may transmit a mobile charge power-supply plan for alternately performing the power supply and the charge at the same charge power-supply facility to the portable information terminal of the target user or the target mobile object. Particularly in a case where the target mobile object is the unmanned self-driving vehicle, the charge and the power supply can be repeated without the target user spending one's time, and therefore, there is a great advantage of transmission of the mobile charge power-supply plan as describe above.

What is claimed is:

1. A charge power-supply management system for managing charge of a power storage device mounted on a target mobile object and power supply from the power storage device, comprising:
a target information acquirer that acquires target information including information on a current location of the target mobile object and a state of the power storage device;
a facility information acquirer that extracts, as a power supply requesting facility, a facility having requested the power supply from a plurality of facilities in a target area including the current location and acquires power supply requesting facility information on the power supply requesting facility;
a margin determinator that determines a presence or absence of a power supply margin in the power storage device based on the target information;
a movement cost calculator that calculates, as a mobile power-supply cost, a cost borne by a target user of the target mobile object for movement of the target mobile object between the current location and the power supply requesting facility;
a user benefit calculator that calculates, as a mobile power-supply benefit, a benefit that can be obtained by the target user in a case of the power supply from the power storage device to the power supply requesting facility; and
a plan transmitter that transmits a mobile power-supply plan generated based on the target information and the power supply requesting facility information to a target terminal of the target user or the target mobile object in a case where it is determined that the power storage device has the power supply margin and the mobile power-supply benefit is greater than the mobile power-supply cost.

2. The charge power-supply management system according to claim 1, wherein
in a case where the current location is identical to a location of a target station set for the target mobile object, the user benefit calculator calculates, as a station power supply benefit, a benefit that can be obtained by the target user in a case of the power supply from the power storage device to the target station, and
in a case where a differential benefit obtained by subtracting the mobile power-supply cost from the mobile power-supply benefit is greater than the station power supply benefit, the plan transmitter transmits the mobile power-supply plan to the target terminal or the target mobile object.

3. The charge power-supply management system according to claim 2, wherein in a case where the target mobile object is an electric vehicle traveling with power from the power storage device, the movement cost calculator calculates the mobile power-supply cost based on an electricity consumption of the target mobile object and an electricity unit price at the target station.

4. The charge power-supply management system according to claim 2, further comprising:
a use schedule determinator that determines whether or not use of the target mobile object is scheduled up to a predetermined time ahead of a current point in time,
wherein in a case where it is determined that the power storage device has the power supply margin and there is no schedule of use of the target mobile object and the differential benefit is greater than the station power supply benefit, the plan transmitter transmits the mobile power-supply plan to the target terminal or the target mobile object.

5. The charge power-supply management system according to claim 2, wherein in a case where the target mobile object is an unmanned self-driving vehicle, the plan transmitter transmits, to the target mobile object, the mobile power-supply plan including information necessary for automatic movement of the target mobile object from the current location to the power supply requesting facility.

6. The charge power-supply management system according to claim 2, wherein
the user benefit calculator successively calculates the mobile power-supply benefit based on latest power supply requesting facility information, and
in a case where the differential benefit becomes less than the station power supply benefit while the target mobile object is moving toward the power supply requesting facility, the plan transmitter transmits a notification of cancelling the notified mobile power-supply plan.

7. A charge power-supply management system for managing charge of a power storage device mounted on a target mobile object and power supply from the power storage device, comprising:
a target information acquirer that acquires target information including information on a current location of the target mobile object and a state of the power storage device;
a facility information acquirer that extracts, as a charge requesting facility, a facility having requested the charge from a plurality of facilities in a target area including the current location and acquires charge requesting facility information on the charge requesting facility;
a margin determinator that determines a presence or absence of a charge margin in the power storage device based on the target information;
a movement cost calculator that calculates, as a mobile charge cost, a cost borne by a target user of the target mobile object for movement of the target mobile object between the current location and the charge requesting facility;
a user benefit calculator that calculates, as a mobile charge benefit, a benefit that can be obtained by the target user in a case of the charge from the charge requesting facility to the power storage device; and
a plan transmitter that transmits a mobile charge plan generated based on the target information and the charge requesting facility information to a target terminal of the target user or the target mobile object in a case where it is determined that the power storage device has the charge margin and the mobile charge benefit is greater than the mobile charge cost.

8. The charge power-supply management system according to claim 7, wherein the user benefit calculator calculates the mobile charge benefit by subtracting a cost borne by the target user in a case of the charge from the charge requesting facility to the power storage device from a cost borne by the target user in a case of the charge from a target station set for the target mobile object to the power storage device.

9. The charge power-supply management system according to claim 8, wherein in a case where the target mobile object is an electric vehicle traveling with power from the power storage device, the movement cost calculator calculates the mobile charge cost based on an electricity consumption of the target mobile object and an electricity unit price at the target station.

10. The charge power-supply management system according to claim 8, further comprising:
a use schedule determinator that determines whether or not use of the target mobile object is scheduled up to a predetermined time ahead of a current point in time,
wherein in a case where it is determined that the power storage device has the charge margin and there is no schedule of use of the target mobile object and the mobile charge benefit is greater than the mobile charge cost, the plan transmitter transmits the mobile charge plan to the target terminal or the target mobile object.

11. The charge power-supply management system according to claim 8, wherein in a case where the target mobile object is an unmanned self-driving vehicle, the plan transmitter transmits, to the target mobile object, the mobile charge plan including information necessary for automatic movement of the target mobile object from the current location to the charge requesting facility.

12. The charge power-supply management system according to claim 8, wherein
the user benefit calculator successively calculates the mobile charge benefit based on latest charge requesting facility information, and
in a case where the mobile charge benefit becomes less than the mobile charge cost while the target mobile object is moving toward the charge requesting facility, the plan transmitter transmits a notification of cancelling the notified mobile charge plan.
